(19) United States
(12) Patent Application Publication
(10) Pub. No.: US 2008/0168510 A1
(43) Pub. Date: Jul. 10, 2008

(54) System and method of routing video data

(75) Inventors: David Small, Dublin, CA (US); Canhui Ou, Danville, CA (US)

Correspondence Address: TOLER LAW GROUP, 8500 BLUFFSTONE COVE, SUITE A201, AUSTIN, TX, 78759, US

(73) Assignee: AT&T Knowledge Ventures, LP, Reno, NV (US)

(21) Appl. No.: 11/651,909

(22) Filed: Jan. 10, 2007

(51) Int. Cl. H04N 7/173

(52) U.S. Cl. 725/100

(57) ABSTRACT

A method of routing video data includes receiving data from a Video on Demand (VoD) content source at a network management system, the data indicating a first set-top box device requesting VoD content. The method also includes identifying an end node group associated with the first set-top box device. The end node group includes a plurality of set-top box devices that share a resource at the VoD content source. Further, the method includes selecting a network path between the VoD content source and the first set-top box device from a set of prospective network paths associated with the first set-top box device. The set of prospective network paths associated with the first set-top box device and network path sets associated with other set-top box devices of the end node group simultaneously satisfy a plurality of constraints related to network path delay and jitter.

### FIELD OF THE DISCLOSURE

The present disclosure is generally related to systems and methods of routing video data.

### BACKGROUND

In a switched network, data may be routed via a plurality of switches from a source to a destination. Data may traverse the network via different physical network paths. Such network paths may have different associated latencies, thereby causing portions of the data to be received at the destination out of sequence or with other complications. Video data, such as that transmitted by Video on Demand (VoD) systems, may be transmitted via switched networks. Such video data, if lost or delayed, may result in an unsatisfactory viewing experience. Nonetheless, avoiding such loss and delay often results in increases in network infrastructure and costs. Hence, there is a need for an improved system and method of routing video data.

### BRIEF DESCRIPTION OF THE DRAWINGS

FIG. 1 is a block diagram of a particular illustrative embodiment of a system to route video data;

FIG. 2 is a block diagram of a second particular illustrative embodiment of a system to route video data;

FIG. 3 is a block diagram of a third particular illustrative embodiment of a system to route video data;

FIG. 4 is a block diagram of a fourth particular illustrative embodiment of a system to route video data;

FIG. 5 is a flow diagram of a particular illustrative embodiment of a method of routing video data;

FIG. 6 is a flow diagram of a particular illustrative embodiment of a method of receiving video data;

FIG. 7 is a flow diagram of a second particular illustrative embodiment of a method of routing video data;

FIG. 8 is a flow diagram of a third particular illustrative embodiment of a method of routing video data; and

FIG. 9 is a general diagram of a particular illustrative embodiment of a computer system.

### DETAILED DESCRIPTION OF THE DRAWINGS

In general, a system and method are disclosed to route video data from a content source to a destination device, such as a set-top box device (STB), via a network. The network may be a switched network, such as a private access network of an Internet Protocol Television (IPTV) system. When data is routed via the network, the data may traverse one or more network paths to reach the destination. In a particular embodiment, a content source can communicate with a network management system that is adapted to determine a set of network paths from the content source to multiple destination devices, where the network paths simultaneously satisfy particular constraints.

In a particular embodiment, a system to route video data is disclosed that includes a network management system having a processor and a memory device accessible to the processor. The memory device includes instructions executable by the processor to receive data from a Video on Demand (VoD) content source at a network management system, the data indicating a first set-top box device requesting VoD content. The memory device also includes instructions executable by the processor to identify an end node group associated with the first set-top box device, wherein the end node group includes a plurality of set-top box devices that share a resource at the VoD content source. The memory device also includes instructions executable by the processor to select a network path between the VoD content source and the first set-top box device from a set of prospective network paths associated with the first set-top box device. The set of prospective network paths associated with the first set-top box device and network path sets associated with other set-top box devices of the end node group simultaneously satisfy a plurality of constraints related to network path delay and jitter.

In another particular embodiment, a method of routing video data is disclosed that includes receiving data from a Video on Demand (VoD) content source at a network management system, the data indicating a first set-top box device requesting VoD content. The method also includes identifying an end node group associated with the first set-top box device, wherein the end node group includes a plurality of set-top box devices that share a resource at the VoD content source. Further, the method includes selecting a network path between the VoD content source and the first set-top box device from a set of prospective network paths associated with the first set-top box device. The set of prospective network paths associated with the first set-top box device and network path sets associated with other set-top box devices of the end node group simultaneously satisfy a plurality of constraints related to network path delay and jitter.

In another embodiment, a processor-readable medium is disclosed that embodies instructions executable by the processor to receive data from a Video on Demand (VoD) content source at a network management system, the data indicating a first set-top box device requesting VoD content. The processor-readable medium also includes instructions executable by the processor to identify an end node group associated with the first set-top box device, wherein the end node group includes a plurality of set-top box devices that share a resource at the VoD content source. The processor-readable medium also includes instructions executable by the processor to select a network path between the VoD content source and the first set-top box device from a set of prospective network paths associated with the first set-top box device. The set of prospective network paths associated with the first set-top box device and network path sets associated with other set-top box devices of the end node group simultaneously satisfy a plurality of constraints related to network path delay and jitter.

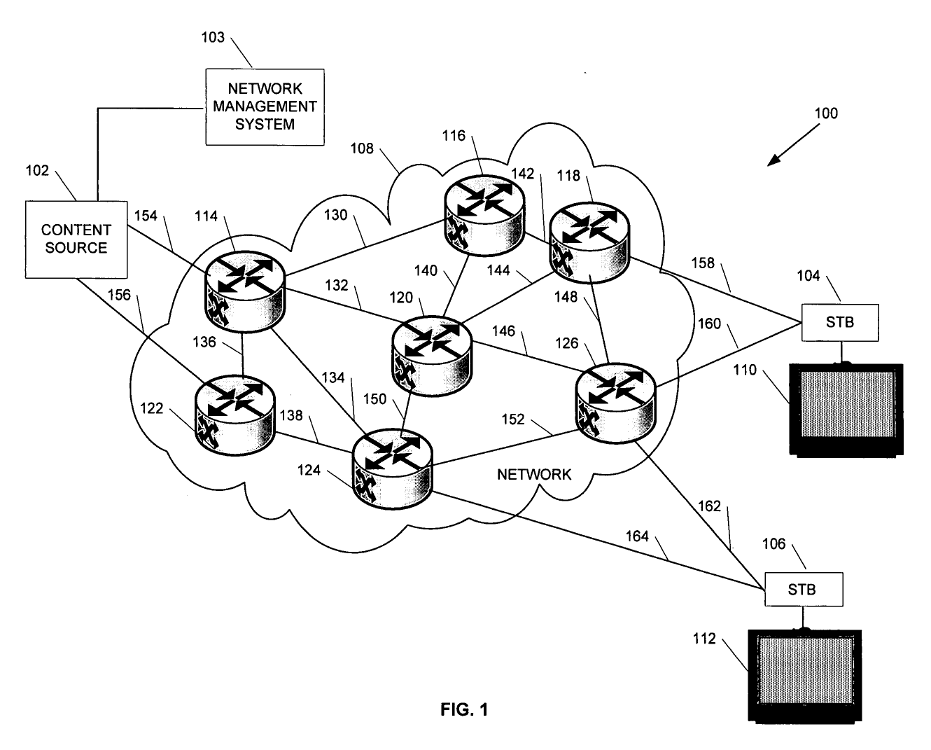

FIG. 1 is a block diagram of a particular illustrative embodiment of a system 1100 to route video data. The system 100 includes a content source 102, a network management system 103, a first set-top box device 104 and a second set-top box device 106. The content source 102 communicates with the first and second set-top box devices 104 and 106 via a network 108. In an illustrative embodiment, the network 108 can be a private access network of an Internet Protocol Television (IPTV) system. The first and second set-top box devices 104 and 106 may receive video content via one or more network paths and may provide the received content to one or more display devices, such as the display devices 110 and 112.

In a particular embodiment, the network 108 can include a plurality of switches 114, 116, 118, 120, 122, 124, and 126, which are communicatively coupled by a plurality of links 130, 132, 134, 136, 138, 140, 142, 144, 146, 148, 150, and 152. In an illustrative embodiment, the content source 102 may be coupled to a first switch 114 via a link 154 and to a second switch 122 via a link 156. In addition, the first set-top box device 104 may be coupled to the switch 118 via a link 158 and to the switch 126 via a link 160. Further, the second set-top box device 106 may be coupled to the switch 126 via a link 162 and to the switch 124 via a link 164.

As used herein, the term link refers to a communication path that connects two switches or that connects a device to a switch. A network path refers to a set of links and switches that define a communication channel between the content source 102 and a destination device, such as the set-top box device 104. For example, a network path from the content source 102 to the first set-top box device 104 can include the switches 114, 116, 118, and the links 154, 130, 142, and 158.

In a particular embodiment, the content source 102 may include one or more servers and associated data stores to provide a VoD service to a plurality of subscribers. The content source 102 may provide multiple services to subscribers and may offer access to a variety of resources to the particular subscriber. In a particular illustrative non-limiting embodiment, a resource at the content source 102 may be a VoD service. In another particular illustrative, non-limiting embodiment, a resource at the content source 102 may be an Internet service, and the content source 102 may serve as an Internet service provider (ISP) to the subscriber. The content source 102 may provide content including text, audio, video, other media content, or any combination thereof, to a destination device via the network 108. In an illustrative embodiment, the content source 102 may provide VoD content from a central or regional video head end (VHE) of an IPTV system to the set-top box devices 104 and 106.

In a particular embodiment, the network management system 103 may determine a set of prospective network paths for communication between the content source 102 and each of a plurality of destination devices. For example, a first network path from the content source 102 to the first set-top box device 104 may include the switches 114, 116, 118, and the links 154, 130, 142, and 158. A second network path from the content source 102 to the first set-top box device 104 may include the switches 114, 124, 126 and the links 154, 134, 152 and 160. A third network path from the content source 102 to the first set-top box device 104 may include the switches 114, 120, 126 and the links 154, 132, 146, and 160. The first, second and third network paths may represent a set of prospective network paths that are associated with the set-top box device 104.

In a particular embodiment, the network management system 103 can associate the first set-top box device 104 with an end node group that includes a plurality of set-top boxes sharing a resource at the content source 102. The set of network paths associated with the first set top box device 104 may be distinct from network path sets associated with other set-top box devices of the end node group, such as a set of network paths associated with the second set-top box device 106. Network paths associated with an end node group can include network path sets associated with each of the set-top box devices of the end node group.

In an illustrative embodiment, the network management system 103 can determine a set of network paths associated with each set-top box device of an end node group, by evaluating performance criteria associated with each possible network path between the content source and the set-top box device. Further, the network management system 103 can select prospective network paths for each set-top box device of an end node group, such that all network paths associated all set-top box devices of the end node group simultaneously satisfy one or more constraints. In a particular embodiment, the sets of network paths associated with the set-top box devices of an end node group can be selected interdependently.

In an exemplary embodiment, all of the network paths associated with the set-top box devices of a particular end node group may simultaneously satisfy a plurality of constraints related to data routing performance, which may include constraints related to network path delay, jitter, network path differential delay, other constraints, or any combination thereof.

In a particular embodiment, the plurality of constraints may include a delay constraint requiring that an expected network path delay for each network path associated with a set-top box device of the end node group does not exceed a pre-defined delay threshold. In another particular embodiment, the plurality of constraints may include a differential delay constraint requiring that a differential path delay for all pairs of network paths associated with the plurality of set-top box devices of the end node group does not exceed a pre-defined differential delay threshold. Differential delay can include a difference in an expected network path delay between two network paths.

In another particular embodiment, the plurality of constraints may include a jitter constraint requiring that a jitter for each network path associated with one of the plurality of set-top box devices of the end node group does not exceed a pre-defined jitter threshold. In general, jitter is a change in network path latency over time for a particular path, which may result in displacement or deviation of some aspects of information in a signal.

In yet another particular embodiment, the plurality of constraints may include a path number constraint requiring that each set of network paths associated with a device of the end node group includes a maximum number, a minimum number, a particular number, or any combination thereof, of network paths. In an illustrative embodiment, the path number constraint can require that each set of network paths associated with a device of the end node group includes one or more shortest network paths between the content source 102 and the device.

In a particular embodiment, the plurality of constraints may include an aggregated delay constraint requiring that a sum of expected network path delays of all network paths associated with the plurality of set-top box devices of the end node group is less than a sum of expected delays of a plurality of alternate network paths. In an illustrative embodiment, each alternate network path can connect one of the set-top box devices of the end node group to the content source, and each set-top box device of the end node group terminates a pre-defined number of alternate network paths.

In a particular embodiment, each of the network paths associated with the plurality of set-top box devices of the end node group can include at least one link. The plurality of constraints can include a path diversity constraint requiring that each network link is included in fewer than a pre-defined number of network paths.

In an illustrative embodiment, the network management system 103 can define a relative importance to one or more constraints and apply one or more weighting factors to the constraints when determining network paths associated with an end node group. For example, the network management system 103 can determine that path diversity is less important than minimizing aggregated delay and can weight the two factors accordingly when selecting network path sets for devices of an end node group.

In a particular illustrative embodiment, the content source 102 may receive a request for Video on Demand (VoD) content from the first set-top box device 104. The content source 102 can send data to the network management system 103 indicating that the set-top box device 104 has requested VoD content. The network management system 103 may determine an end node group associated with the first set-top box device 104. The network management system 103 may select a network path between the content source 102 and the first set-top box device 104 from a set of prospective network paths associated with the first set-top box device 104. In a particular embodiment, the network management system 103 can send data indicating the selected network path to the content source 102, and the content source 102 may send VoD content to the first set-top box device 104 via the selected network path.

In an illustrative, non-limiting embodiment, the network 108 may be a MultiProtocol Switching (MPLS) network. A switch, such as the switch 114, may add a label to each packet of data received from the content source 102. This label may be based on some criteria (such as a destination Internet Protocol address, a quality of service requirement, other criteria, or a combination thereof). The label may be used to steer data through the subsequent switches to a destination device (e.g., the first set-top box device 104). Another switch, such as the switch 118 or 126, may remove the label before final delivery of the original data packet. In a particular illustrative embodiment, Multi-Protocol Label Switching Label Switch Paths (MPLS LSP) may be provisioned from the network paths associated with an end node group, by determining explicitly routed Multi-Protocol Label Switching Label Switch Paths between the content source 102 and each device of the end node group.

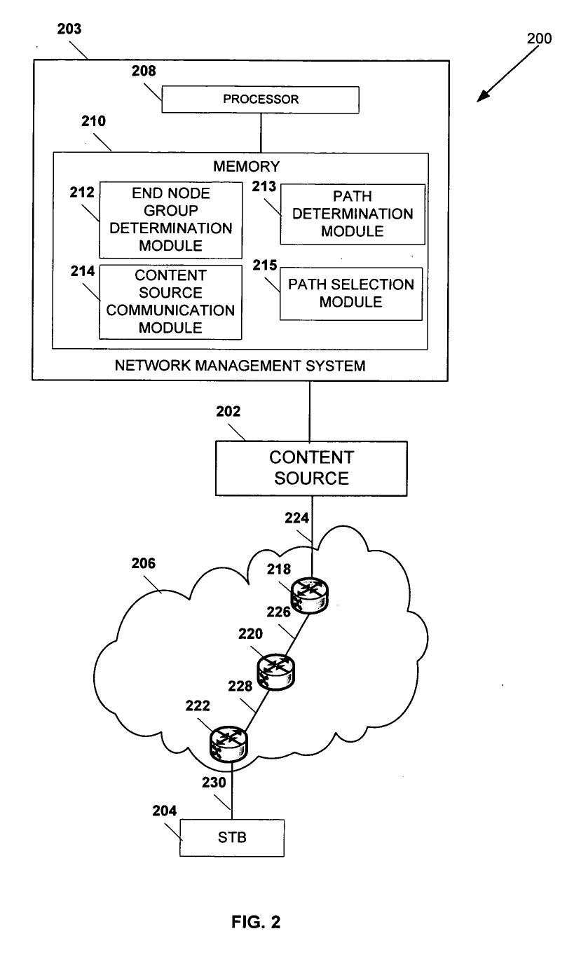

FIG. 2 is a block diagram of a second particular illustrative embodiment of a system 200 to route video data. The system 200 includes a content source 202 that communicates with a set-top box device (STB) 204 via a network 206. The content source also communicates with a network management system 203. In a particular embodiment, the content source 202 may be adapted to provide video content to the set-top box device 204 via a network path that includes switches 218, 220, and 222, and links 224, 226, 228 and 230. In an illustrative embodiment, the content source 202 may provide video-on-demand (VoD) content from a central or regional video head end of an Internet Protocol Television (IPTV) system to the set-top box device 204.

In a particular embodiment, the network management system 203 may include a processor 208 and a memory 210. The memory 210 may include an end node group determination module 212, a path determination module 213, a content source communication module 214, and a path selection module 215. The various modules 212-215 can include hardware logic, processor-executable instructions, or any combination thereof.

In a particular embodiment, the end node group determination module 212 can include instructions executable by the processor to associate set-top box devices, such as the set-top box device 204, with one or more end node groups. An end node group can include, for example, multiple set-top box devices that share a common resource at the content source 202, such as a VoD service.

In a particular embodiment, the path determination module 213 may be executable by the processor 208 to evaluate performance characteristics of various network paths from the content source 202 to the set-top box device 204. Further, the path determination module 213 may be executable by the processor 208 to determine a set of prospective network paths associated with the set-top box device 204 by comparing such performance characteristics with pre-defined performance criteria that simultaneously apply to all network paths associated with devices of an end node group that includes the set-top box device 204.

For example, the network management system 203 may determine an expected performance characteristic such as network path delay, jitter, or a combination thereof, for each network path from the content source 202 to the set-top box device 204. The network management system 203 may select a set of prospective network paths to be associated with the first set-top box device 204, such that performance characteristics of the set of prospective network paths to be associated with the first set-top box device 204, and performance characteristics of prospective network paths associated with the other devices of the end node group, simultaneously satisfy the performance criteria.

In a particular embodiment, the content source communication module 214 may be executable by the processor 208 to receive data from the content source 202 indicating a request for content from a set-top box device, such as the set-top box device 204. The network path selection module 215 may be executable by the processor 208 to determine an end node group associated with the set-top box device 204 and to select a network path from the set of prospective network paths associated with the set-top box device 204 based, for example, on current performance of the selected network path, past performance of the selected network path, projected performance of the selected network path, network traffic, bandwidth required by the video data, distance traversed by the selected network path, other factors to select a network path from a set of prospective network paths, or any combination thereof. The content source communication module 214 may be executable by the processor 208 to send data indicating the selected network path to the content source 202. The content source 202 can send requested content to the set-top box device 204 via the selected network path, such as the network path including switches 218-222 and links 224-230.

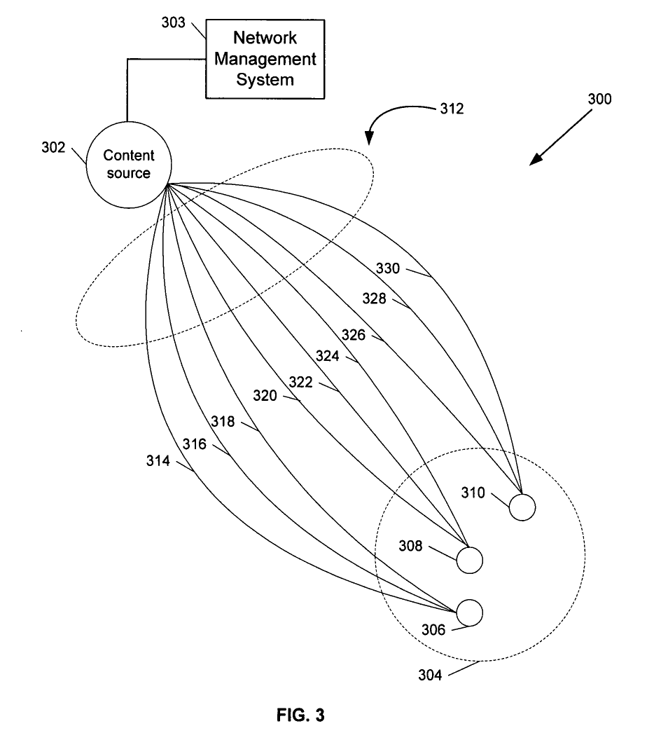

FIG. 3 is a block diagram of a third particular illustrative embodiment of a system 300 to route video data. The system 300 includes a content source 302 that communicates with devices 306-310 of an end node group 304 via multiple network paths 314-330. The content source 302 also communicates with a network management system 303. In general, particular network paths may be associated with particular end nodes at the network management system 303. For example, the network paths 314, 316, and 318 may define a first set of network paths to facilitate communication between the content source 302 and a first end node 306. The network paths 320, 322, and 324 may define a second set of network paths to facilitate communication between the content source 302 and a second end node 308. The network paths 326, 328 and 330 may define a third set of network paths to facilitate communication between the content source 302 and a third end node 310. Each of the end nodes 306, 308, and 310 may share a particular resource at the content source 302, such as a Video on Demand (VoD) resource. In a particular embodiment, each end node 306, 308, and 310 can be a set-top box device, such as the first set-top box device 104 or the second set-top box device 106, illustrated in FIG. 1.

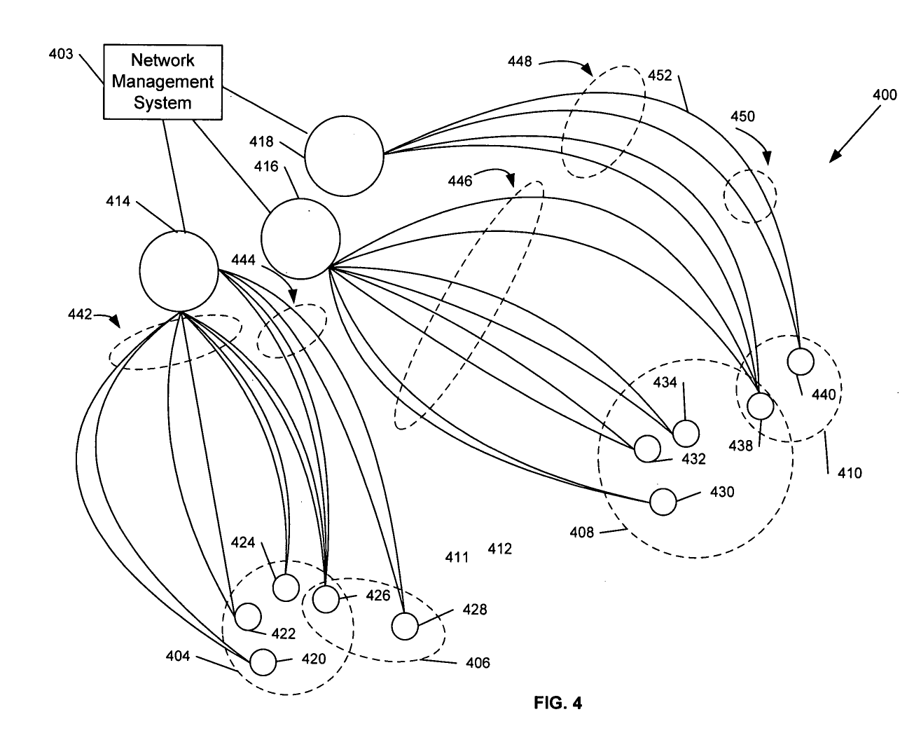

FIG. 4 is a block diagram of a third particular illustrative embodiment of a system 400 to route video data. The system 400 includes a first content source 414, a second content source 416, and a third content source 418, which communicate with end node groups 404, 406, 408, and 410 via the network paths 442-448. Further, the content sources 414-418 communicate with a network management system 403. In an illustrative embodiment, a first end node group 404 can include end nodes 420, 422, 424 and 426. A second end node group 406 can overlap with the first end node group 404 and can include the end node 426 and an end node 428. A third end node group 408 includes end nodes 430, 432, 434, and 438. A fourth end node group 410 can overlap with the third end node group 408 and can include the end node 438 and an end node 440.

In an illustrative, non-limiting embodiment, the network management system 403 can associate a set of network paths with each end node of a particular end node group, such as the end node groups 404, 406, 408 and 410. For example, the content source 418 may determine a group of network paths 448 that is associated with the end node group 410. The group of network paths can include multiple sets of network paths, where each set is associated with a device of the end node group. For instance, a set of network paths 450 may be associated with the end node 440 of the end node group 410.

In a particular illustrative embodiment, one or more end node devices can be associated with multiple end node groups. For instance, the end node 438 may be associated with the end node groups 408 and 410. The network management system 403 may associate a set of prospective network paths with the end node 438 for transmission of content from the second content source 416, and the network management system 403 may associate a distinct set of prospective network paths with the end node 438 for transmission of content from the third content source 418.

In general, the network management system 403 can determine sets of prospective network paths to associate with each end node device based on one or more performance constraints related to network path delay and jitter. Such constraints can relate to individual network paths; to a particular set of network paths associated with an individual device, such as the set of network paths 450; to all network paths associated with an end node group, such as the groups of network paths 442 or 444; to multiple groups of network paths, for example, when a device is included in multiple groups; or any combination thereof.

In a particular illustrative embodiment, the third content source 418 may receive a request for VoD content from the end node 440. The third content source 418 may send data to the network management system 403 indicating the request. The network management system 403 determines the end node group 410 that includes the end node 440. The network management system 403 may select a network path 452, for example, from the set of prospective network paths 450 associated with the end node 440 and may send data to the third content source 418 indicating that the network path 452 has been selected. The third content source 418 may send the VoD content via the selected network path 452.

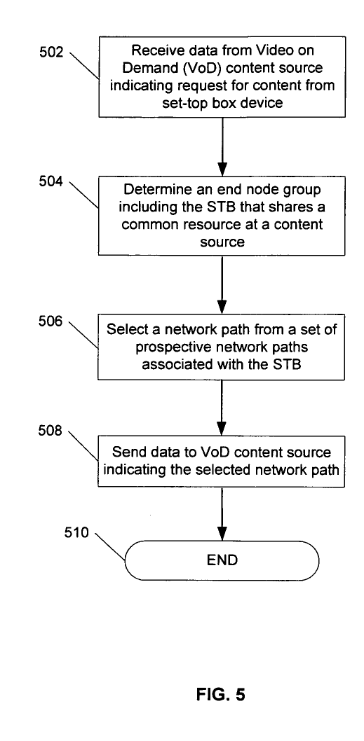

FIG. 5 is a flow diagram of a particular illustrative embodiment of a method of routing video data. At block 502, a network management system receives data from video-on-demand (VoD) content source indicating that a set-top box device has requested VoD content. Moving to block 504, the network management system identifies an end node group that includes the set-top box device. In a particular embodiment, the end node group can include a plurality of set-top box devices sharing a resource at the VoD content source.

Continuing to block 506, the network management system selects a network path from a set of prospective network paths associated with the set-top box device. The set of prospective network paths are included in a group of network paths associated with the end node group, and all network path sets associated with devices of the end node group simultaneously satisfy a plurality of constraints related to network path delay, jitter, other constraints, or any combination thereof. Proceeding to block 508, in a particular embodiment, the network management system sends data indicating the selected content to the VoD content source. The method terminates at 510.

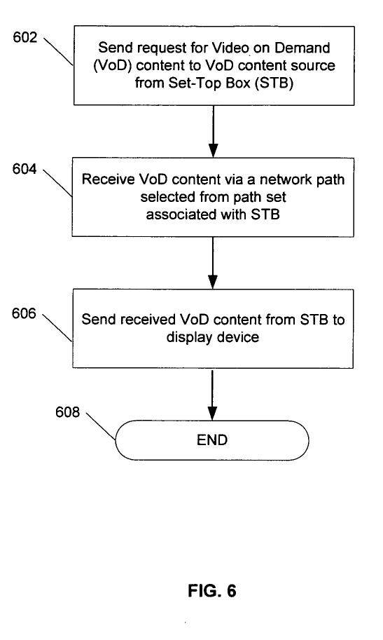

FIG. 6 is a flow diagram of a particular illustrative embodiment of a method of receiving video data. At block 602, a set-top box device sends a request for video-on-demand (VoD) content to a VoD content source. Moving to block 604, the set-top box device receives VoD content via a network path selected from a set of network paths associated with the set-top box device. For example, the selected path may satisfy a plurality of constraints related to network path delay and jitter between the content source and the set-top box device. In a particular illustrative embodiment, at block 606, the set-top box device sends the received VoD content to a display device. The method terminates at 608.

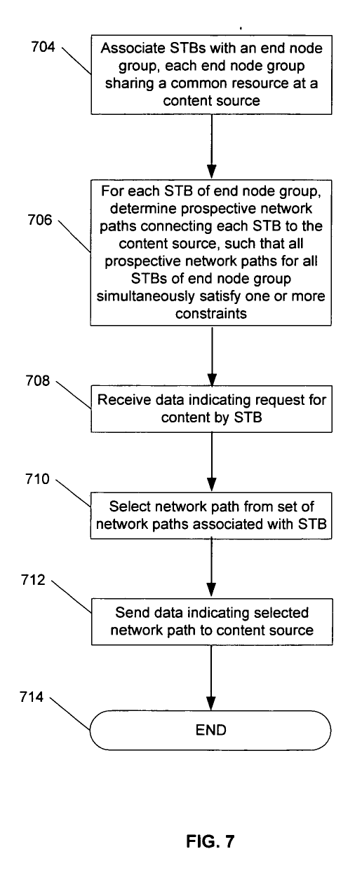

FIG. 7 is a flow diagram of a second particular illustrative embodiment of a method of routing video data. At block 704, a network management system associates a plurality of set-top box devices with an end node group, where each set-top box device of an end node group shares a common resource at a content source. Moving to block 706, the network management system determines a set of prospective network paths for each set-top box device of the end node group. Each of the network paths associated with the set-top box devices of the end node group satisfy a plurality of constraints related to network path delay and jitter associated with content transmission.

In an illustrative embodiment, the set of prospective network paths can include one or more shortest loopless paths communicatively connecting the set-top box device with the content source, where each network path of the set of prospective network paths is considered when determining a network path to send data to the set-top box device. In a particular embodiment, each set of prospective network paths associated with a set-top box device of the end node group may be distinct from other network path sets associated with other set-top box devices of the end node group.

Proceeding to block 708, the network management system receives data from a content source indicating that a set-top box device has requested content. Continuing to block 710, the network management system selects a network path from a set of prospective network paths associated with the set-top box device. Advancing to block 712, the network management system sends data to the content source indicating the selected network path. The method terminates at 714.

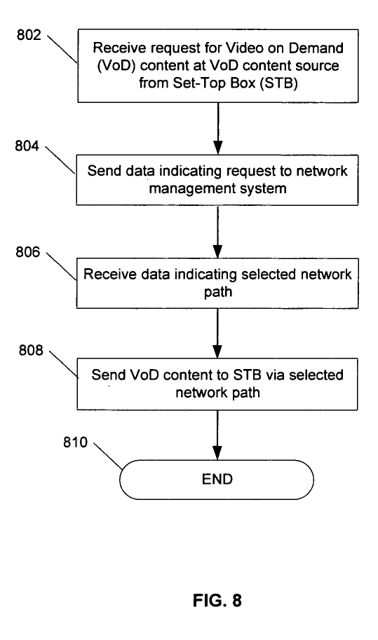

FIG. 8 is a flow diagram illustrating a third particular illustrative embodiment of a method of routing video data. At block 802, a video-on-demand (VoD) content source receives a request for VoD content. Moving to block 804, the VoD content source sends data indicating the request to a network management system. At block 806, the VoD content source receives data indicating a selected network path from the network management system. Proceeding to block 808, the VoD content source sends the requested VoD content to the set-top box device via the selected network path. The method terminates at 810.

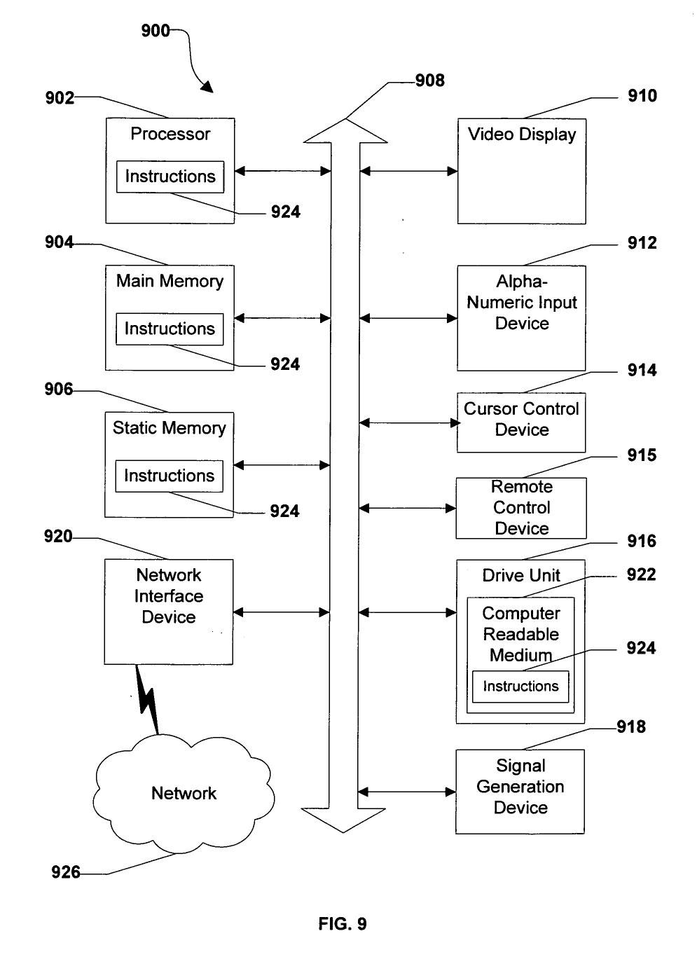

FIG. 9 is a general diagram of a particular illustrative embodiment of a computer system 900. The computer system 900 can include a set of instructions that can be executed to cause the computer system 900 to perform any one or more of the methods or computer based functions disclosed herein. The computer system 900 may operate as a standalone device or may be connected, e.g., using a network, to other computer systems or peripheral devices.

In a networked deployment, the computer system may operate in the capacity of a content source, network management system, set-top box device, or network switch, as illustrated in FIGS. 1-4. The computer system 900 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 900 can be implemented using electronic devices that provide voice, video or data communication. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, e.g., a central processing unit (CPU), a graphics processing unit (GPU), or both. Moreover, the computer system 900 can include a main memory 904 and a static memory 906, which can communicate with each other via a bus 908. As shown, the computer system 900 may further include a video display unit 910, such as a liquid crystal display (LCD), an organic light emitting diode (OLED), a flat panel display, a solid state display, or a cathode ray tube (CRT). Additionally, the computer system 900 may include an input device 912, such as a keyboard, a cursor control device 914, such as a mouse, and a remote control device 915. The computer system 900 can also include a disk drive unit 916, a signal generation device 918, such as a speaker or remote control, and a network interface device 920.

In a particular embodiment, as depicted in FIG. 9, the disk drive unit 916 may include a computer-readable medium 922 in which one or more sets of instructions 924, e.g. software, can be embedded. Further, the instructions 924 may embody one or more of the methods or logic as described herein. In a particular embodiment, the instructions 924 may reside completely, or at least partially, within the main memory 904, the static memory 906, and/or within the processor 902 during execution by the computer system 900. The main memory 904 and the processor 902 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 924 or receives and executes instructions 924 responsive to a propagated signal, so that a device connected to a network 926 can communicate voice, video or data over the network 926. Further, the instructions 924 may be transmitted or received over the network 926 via the network interface device 920.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of routing video data, the method comprising:
receiving data from a Video on Demand (VoD) content source at a network management system, the data indicating a first set-top box device requesting VoD content;
identifying an end node group associated with the first set-top box device, wherein the end node group includes a plurality of set-top box devices that share a resource at the VoD content source; and
selecting a network path between the VoD content source and the first set-top box device from a set of prospective network paths associated with the first set-top box device, wherein the set of prospective network paths associated with the first set-top box device and network path sets associated with other set-top box devices of the end node group simultaneously satisfy a plurality of constraints related to network path delay and jitter.

2. The method of claim 1, wherein the VoD content is sent from the VoD content source to the first set-top box device via the selected network path.

3. The method of claim 1, wherein the plurality of constraints includes a delay constraint requiring that an expected network path delay for each network path associated with a set-top box device of the end node group does not exceed a pre-defined delay threshold.

4. The method of claim 1, wherein the plurality of constraints includes a differential delay constraint requiring that a differential path delay for all pairs of network paths associated with the plurality of set-top box devices of the end node group does not exceed a pre-defined differential delay threshold.

5. The method of claim 1, wherein the plurality of constraints includes a jitter constraint requiring that a jitter for each network path associated with one of the plurality of set-top box devices of the end node group does not exceed a pre-defined jitter threshold.

6. The method of claim 1, wherein each network path set associated with one of the plurality of set-top box devices of the end node group includes one or more shortest network paths connecting the set-top box device with the content source.

7. The method of claim 1, wherein:
the plurality of constraints includes an aggregated delay constraint requiring that a sum of expected network path delays of all network paths associated with the plurality of set-top box devices of the end node group is less than a sum of expected delays of a plurality of alternate network paths;
each alternate network path connects one of the set-top box devices of the end node group to the content source; and
each set-top box device of the end node group terminates a pre-defined number of alternate network paths.

8. The method of claim 1, wherein each of the network paths associated with the plurality of set-top box devices of the end node group includes at least one link and wherein the plurality of constraints includes a path diversity constraint requiring that each network link is included in fewer than a pre-defined number of network paths.

9. The method of claim 1, further comprising defining a relative importance of a constraint and applying a weighting factor to the constraint.

10. The method of claim 1, further comprising provisioning a plurality of Multi-Protocol Label Switching Label Switch Paths (MPLS LSP) based on the network paths associated with the set-top box devices of the end node group.

11. A system to route data, the system comprising:
a network management system having a processor and a memory device accessible to the processor, wherein the memory device includes instructions executable by the processor to:
receive data from a Video on Demand (VoD) content source at a network management system, the data indicating a first set-top box device requesting VoD content;
identify an end node group associated with the first set-top box device, wherein the end node group includes a plurality of set-top box devices that share a resource at the VoD content source; and
select a network path between the VoD content source and the first set-top box device from a set of prospective network paths associated with the first set-top box device, wherein the set of prospective network paths associated with the first set-top box device and network path sets associated with other set-top box devices of the end node group simultaneously satisfy a plurality of constraints related to network path delay and jitter.

12. The system of claim 11, wherein a differential path delay related to all pairs of network paths associated with the plurality of set-top box devices of the end node group is less than a differential delay threshold.

13. The system of claim 11, wherein an expected network path delay of each network path associated with a set-top box device of the end node group is less than a network path delay threshold.

14. The system of claim 11, wherein a jitter parameter of each network path associated with a set-top box device of the end node group is less than a jitter threshold.

15. A processor-readable medium tangibly embodying instructions executable by a processor to:
receive data from a Video on Demand (VoD) content source at a network management system, the data indicating a first set-top box device requesting VoD content;
identify an end node group associated with the first set-top box device, wherein the end node group includes a plurality of set-top box devices that share a resource at the VoD content source; and
select a network path between the VoD content source and the first set-top box device from a set of prospective network paths associated with the first set-top box device, wherein the set of prospective network paths associated with the first set-top box device and network path sets associated with other set-top box devices of the end node group simultaneously satisfy a plurality of constraints related to network path delay and jitter.

16. The processor-readable medium of claim 15, further comprising instructions executable by the processor to associate each of the plurality of set-top box devices with at least one end node group, wherein each end node group shares a resource at a video content source.

17. The processor-readable medium of claim 16, further comprising instructions executable by the processor to select a group of network path sets for each end node group, wherein each network path set is associated with one of the plurality of set-top box devices.

18. The processor-readable medium of claim 17, wherein each network path set is distinct from the other network path sets in the group of network path sets.

19. The processor-readable medium of claim 17, further comprising instructions to:
associate the plurality of set-top box devices with a first end node group and a second end node group, wherein the first end node group shares a first resource at the video content source and the second end node group shares a second resource at the video content source; and
select a first group of network path sets associated with the first end node group and a second group of network path sets associated with the second end node group.

20. The processor-readable medium of claim 19, wherein at least one of the plurality of set-top box devices is associated with the first end node group and with the second end node group.
